(19) United States
(12) Patent Application Publication
(10) Pub. No.: US 2025/0372832 A1
(43) Pub. Date: Dec. 4, 2025

(54) SECONDARY BATTERY AND METHOD FOR MANUFACTURING THE SAME

(71) Applicant: SAMSUNG SDI CO., LTD., Yongin-Si Gyeonggi-do (KR)

(72) Inventor: Taewoong JANG, Yongin-Si (KR)

(21) Appl. No.: 18/932,110

(22) Filed: Oct. 30, 2024

(30) Foreign Application Priority Data
Jun. 4, 2024 (KR) 10-2024-0073340

(51) Int. Cl. H01M 50/533; H01M 10/04

(52) U.S. Cl. CPC H01M 50/533; H01M 10/0431

(57) ABSTRACT

A secondary battery includes: an electrode assembly including: a first electrode; a second electrode; and a separator between the first electrode and the second electrode, the first electrode and the second electrode being wound together with the separator therebetween; an electrode tab connected to the first electrode; a case having an opening at one side, and to accommodate the electrode assembly; and a cap assembly coupled to the one side of the case to seal the opening of the case, and including a terminal plate electrically connected to the electrode tab connected to the first electrode. The electrode tab includes a plurality of edges, and at least one of the plurality of edges is chamfered.

### CROSS-REFERENCE TO RELATED APPLICATION

The present application claims priority to and the benefit of Korean Patent Application No. 10-2024-0073340, filed on Jun. 4, 2024, in the Korean Intellectual Property Office, the entire disclosure of which is incorporated by reference herein.

### BACKGROUND

### 1. Field

Aspects of embodiments of the present disclosure relate to a secondary battery, and a method for manufacturing the secondary battery.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

Electrode tabs may be formed on the electrode assembly of the secondary battery. During the use of the secondary battery, the electrode assembly may contract and expand during charging and discharging. The electrode tabs of the electrode assembly may move as the electrode assembly is charged and discharged inside the case. In addition, vibrations or drops of the secondary battery may also cause the electrode tabs to move. When the electrode tabs move and come into contact with components inside the secondary battery, the components may be damaged. If the components inside the secondary battery are damaged, an internal short circuit may occur in the secondary battery.

Embodiments of the present disclosure may be directed to a secondary battery including a chamfered electrode tab, and a method for manufacturing the secondary battery.

These and other aspects and features of the present disclosure will be described in or will be apparent from the following description of embodiments of the present disclosure.

According to one or more embodiments of the present disclosure, a secondary battery includes: an electrode assembly including: a first electrode; a second electrode; and a separator between the first electrode and the second electrode, the first electrode and the second electrode being wound together with the separator therebetween; an electrode tab connected to the first electrode; a case having an opening at one side, and configured to accommodate the electrode assembly; and a cap assembly coupled to the one side of the case to seal the opening of the case, and including a terminal plate electrically connected to the electrode tab connected to the first electrode. The electrode tab includes a plurality of edges, and at least one of the plurality of edges is chamfered.

In an embodiment, a top surface of the electrode tab may face the terminal plate, and at least one edge of the top surface from among the plurality of edges may be chamfered.

In an embodiment, the electrode tab may include a first side surface located at one end of the electrode tab, another end of the electrode tab that is opposite to the one end may be connected to the first electrode, and at least one edge of the first side surface from among the plurality of edges may be chamfered.

In an embodiment, a top surface of the electrode tab may face the terminal plate, the plurality of edges may include a first edge, the first side surface of the electrode tab may include the first edge that may be connected with the top surface of the electrode tab, and the first edge may be chamfered.

In an embodiment, the plurality of edges may include a first edge, a second edge, a third edge, and a fourth edge, the first side surface of the electrode tab may include: the second edge opposite to the first edge; and the third edge and the fourth edge, each of which may be connected to the first edge and the second edge, and at least one of the second edge, the third edge, or the fourth edge may be chamfered.

In an embodiment, the electrode tab may include: a contact portion in contact with the terminal plate; a bridge portion connecting the first electrode and the contact portion to each other; and a bending portion between the contact portion and the bridge portion.

In an embodiment, the plurality of edges may further include a fifth edge, a top surface of the contact portion may face the terminal plate, the top surface of the contact portion may include the fifth edge at one end opposite to the bending portion, and the fifth edge may be chamfered.

In an embodiment, the plurality of edges may further include a sixth edge and a seventh edge, the top surface of the contact portion may include the sixth edge and the seventh edge, each connected to the fifth edge and the bending portion, and at least a portion of the sixth edge and at least a portion of the seventh edge may be chamfered.

In an embodiment, the plurality of edges may further include an eighth edge and a ninth edge, a top surface of the bridge portion may face the terminal plate, the top surface of the bridge portion may include the eighth edge and the ninth edge, each connected to the bending portion, and at least a portion of the eighth edge and at least a portion of the ninth edge may be chamfered.

In an embodiment, the at least one of the plurality of edges may be chamfered by cutting or rolling.

In an embodiment, a width of the at least one of the plurality of edges that is chamfered may be in a range from 20 μm to 150 μm.

In an embodiment, the at least one of the plurality of edges that is chamfered may be a rounded edge.

In an embodiment, the terminal plate may include a body portion, and an insertion portion protruding from the body portion. The cap assembly may further include: a cap plate fitted into and coupled to the opening of the case, the cap plate having a through-hole through which the insertion portion of the terminal plate may be configured to pass through; and an insulating member on a bottom surface of the cap plate.

In an embodiment, the terminal plate may be electrically connected to the electrode tab by the insertion portion contacting the electrode tab.

In an embodiment, a thickness of the insulating member may be 30 μm or more.

In an embodiment, a distance from the bottom surface of the cap plate to a bottom surface of the insertion portion may be in a range from 80 μm and 180 μm.

In an embodiment, the electrode tab may be spaced from the insulating member by the insertion portion of the terminal plate when the cap assembly is coupled to the case accommodating the electrode assembly.

In an embodiment, the secondary battery may be a coin kind or a button kind.

According to one or more embodiments of the present disclosure, a method for manufacturing a secondary battery, includes: forming a chamfered edge by chamfering at least one of a plurality of edges of an electrode tab; connecting the electrode tab having the chamfered edge to a first electrode; forming an electrode assembly by winding the first electrode and a second electrode together with a separator disposed between the first electrode and the second electrode; accommodating the electrode assembly in a case having an opening formed at one side; and coupling a cap assembly to the one side of the case to seal the opening of the case. The cap assembly includes a terminal plate electrically connected to the electrode tab connected to the first electrode.

In an embodiment, the forming of the chamfered edge may include chamfering the at least one of the plurality of edges of the electrode tab to have a rounded shape through at least one of cutting or rolling.

According to some embodiments of the present disclosure, the bending portion may serve as a buffer, even if the electrode tab moves in the secondary battery. Thus, it may be possible to prevent or substantially prevent damage to the electrode tab. Additionally, a contact between the electrode tab and a bottom surface of a cap plate and/or a contact between the electrode tab and an insulating member may be reduced. Therefore, it may be possible to prevent or substantially prevent damage to the cap plate and/or the insulating member.

According to some embodiments of the present disclosure, edges of a top surface of a bridge portion and/or edges of a top surface of a contact portion in the electrode tab that is chamfered may result in the edges of the electrode tab being blunt. Further, or as another example, edges of a first side surface of the electrode tab and/or the edges of the top surface of the contact portion that is chamfered may result in the edges of the electrode tab being blunt. As a result, a contact of the insulating member with the electrode tab may not cause damage to the insulating member.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a cross-sectional view of a secondary battery according to an embodiment of the present disclosure;

FIG. 2 is a cross-sectional view of a cap assembly and an electrode tab according to an embodiment of the present disclosure;

FIG. 3 is a partial enlarged view of an electrode tab according to an embodiment of the present disclosure;

FIG. 4 is a side view of a chamfered electrode tab according to an embodiment of the present disclosure;

FIG. 5 is a side view of a chamfered electrode tab according to an embodiment of the present disclosure;

FIG. 6 is a cross-sectional view of a chamfered electrode tab according to an embodiment of the present disclosure;

FIG. 7 is a cross-sectional view of a chamfered electrode tab according to an embodiment of the present disclosure;

FIG. 8 illustrates an example of an electrode tab according to an embodiment of the present disclosure;

FIG. 9 illustrates an example of a cap assembly and an electrode tab according to an embodiment of the present disclosure; and

FIG. 10 is a flowchart illustrating an example of a method for manufacturing a secondary battery according to an embodiment of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132 (a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

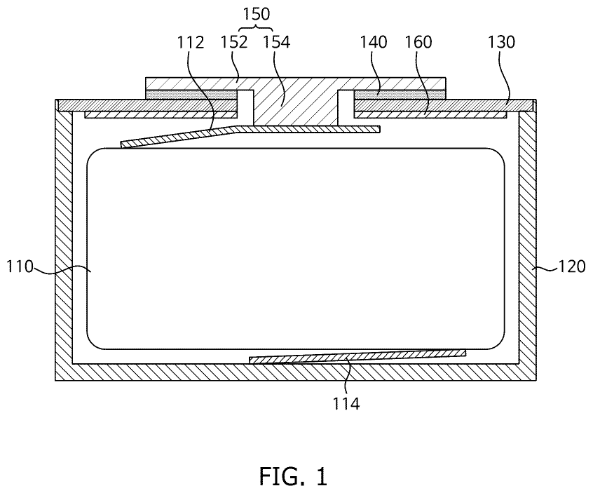

FIG. 1 is a cross-sectional view of a secondary battery according to an embodiment of the present disclosure. FIG. 1 may be a cross-sectional view showing 1 a structure in which the secondary battery having a cylindrical shape is vertically cut along a line crossing the center thereof. As shown in FIG. 1, the secondary battery may include an electrode assembly 110, a case 120, and a cap assembly.

The secondary battery may be a coin-kind of secondary battery or a button-kind of secondary battery. For example, the secondary battery may have a cylindrical shape, but the shape the secondary battery is not limited thereto.

The electrode assembly 110 may include a first electrode, a second electrode, and a separator. In more detail, the electrode assembly 110 may be configured by winding the first electrode and the second electrode together, with the separator disposed between the first electrode and the second electrode. The electrode assembly 110 may be wound to form a winding core, and may include a through-hole in the winding core.

The first electrode may include a first substrate, and a first active material layer applied onto the first substrate. A first electrode tab 112 may extend outward from a first uncoated portion where the first active material layer is not applied on the first substrate, and the first electrode tab 112 may be electrically connected to a terminal plate 150 of the cap assembly.

The second electrode may include a second substrate, and a second active material layer applied onto the second substrate. A second electrode tab 114 may extend outward from a second uncoated portion where the second active material layer is not applied on the second substrate, and the second electrode tab 114 may be electrically connected to the case 120. The first electrode tab 112 and the second electrode tab 114 may extend in opposite directions from each other from the first electrode and the second electrode, respectively.

In an embodiment, each of the first electrode tab 112 and the second electrode tab 114 may be covered with a cover tape. The cover tape may include an insulating material. The insulating material may provide an electrical insulation to prevent or substantially prevent a current from passing therethrough. The cover tape may prevent a short circuit from occurring at the first electrode tab 112 and the second electrode tab 114.

The first electrode may serve as a positive electrode. In this case, the first substrate may include (e.g., may be composed of), for example, an aluminum foil, and the first active material layer may include, for example, a transition metal oxide. The second electrode may serve as a negative electrode. In this case, the second substrate may include (e.g., may be composed of), for example, a copper foil or a nickel foil, and the second active material layer may include, for example, graphite.

The separator may function to prevent a short circuit between the first electrode and the second electrode, while allowing the movement of ions (e.g., lithium ions). The separator may include (e.g., may be composed of), for example, a polyethylene film, a polypropylene film, a polyethylene-polypropylene film, or the like, but the present disclosure is not limited thereto.

Referring to FIG. 1, the first electrode tab 112 of the first electrode may be formed on one side of the electrode assembly 110. The second electrode tab 114 of the second electrode may be formed on another side (e.g., an opposite side) of the electrode assembly 110. However, the present disclosure is not limited thereto. For example, the first electrode tab 112 and the second electrode tab 114 may be formed on one side (e.g., on the same side) of the electrode assembly 110.

The case 120 may accommodate the electrode assembly 110 and an electrolyte, and may form an external appearance of the secondary battery together with the cap assembly. The case 120 may include a cylindrical or substantially cylindrical sidewall portion, and a bottom portion connected to one side of the sidewall portion. However, the present disclosure is not limited thereto, and the case 120 may have various suitable shapes, such as a circular shape, a pouch shape, or the like. In addition, the case 120 may include (e.g., may be composed of) a metal, such as aluminum, an aluminum alloy, or a nickel-plated steel, or a laminated film or a plastic used for a pouch.

The case 120 may accommodate the electrode assembly 110. The electrode assembly 110 may be inserted into the case 120 through an opening formed at one side of the case 120. The opening of the case 120 may then be closed (e.g., may be covered) by the cap assembly. The cap assembly may be connected to (e.g., coupled to or attached to) the one side of the case 120.

The cap assembly may include a cap plate 130, the terminal plate 150, and an insulating layer 140. The cap plate 130 may seal the opening of the case 120. The cap plate 130 may be connected to (e.g., coupled to or attached to) a side surface of the case 120 corresponding to a side surface in which the opening is formed.

An insertion hole may be formed at the cap plate 130. In more detail, the insertion hole may be formed approximately at the center of the cap plate 130. The terminal plate 150 may be inserted into the insertion hole, and may be connected to (e.g., coupled to or attached to) the cap plate 130. The terminal plate 150 may include a body portion 152, and an insertion portion 154 protruding from the body portion 152.

The insertion portion 154 of the terminal plate 150 may be inserted into the insertion hole of the cap plate 130.

The insulating layer 140 may be disposed between the terminal plate 150 and the cap plate 130. The insulating layer 140 may have adhesive properties to bond the terminal plate 150 and the cap plate 130 to each other. The insulating layer 140 may be formed of an insulating material to electrically insulate between the terminal plate 150 and the cap plate 130.

In an embodiment, the insulating member 160 may be disposed on a bottom surface of the cap plate 130. The bottom surface of the cap plate 130 may face the electrode assembly 110. The insulating member 160 may include (e.g., may be made of) an insulating material to provide an insulation between the cap plate 130 and the electrode assembly 110, and/or between the cap plate 130 and the first electrode tab 112. The insulating member 160 may have a suitable thickness (e.g., a predetermined thickness) to protect the cap plate 130. For example, a thickness of the insulating member 160 may be 30 μm or more.

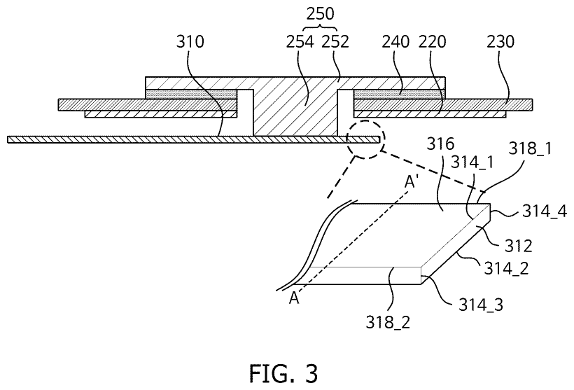

In an embodiment, the first electrode tab 112 may have a plurality of edges. As used herein, an edge may refer to a corner where two faces (e.g., two surfaces, sides, or ends) meet each other. For example, a hexahedron (e.g., a cuboid) may have 12 edges. At least one of the edges may be chamfered. The structure of the chamfered edge will be described in more detail below with reference to FIGS. 3 to 7.

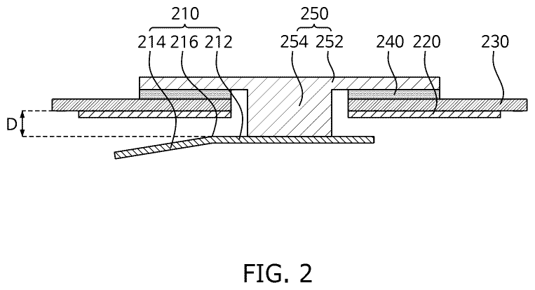

In an embodiment, the first electrode tab 112 may include a contact portion that contacts the terminal plate 150, a bridge portion connecting the contact portion to the first electrode, and a bending portion formed between the contact portion and the bridge portion. The structure of the contact portion, the bridge portion, and the bending portion of the first electrode tab 112 will be described in more detail below with reference to FIG. 2.

FIG. 2 is a cross-sectional view of a cap assembly and an electrode tab 210 according to an embodiment of the present disclosure. A configuration of the cap assembly shown in FIG. 2 may be the same or substantially the same as that of the cap assembly described above with reference to FIG. 1. Hereinafter with reference to FIG. 2, a structure of the electrode tab 210, and a contact structure between the electrode tab 210 and the cap assembly may be mainly described in more detail.

The cap assembly may include an insulating member 220, a cap plate 230, an insulating layer 240, and a terminal plate 250. The terminal plate 250 may include a body portion 252 and an insertion portion 254. The insulating layer 240 may be disposed between the body portion 252 and the cap plate 230. The insertion portion 254 may be inserted into an insertion hole formed in the cap plate 230.

The electrode tab 210 may be connected to the first electrode. In an embodiment, the electrode tab 210 may include a contact portion 212 that contacts the terminal plate 250. Referring to FIG. 2, the electrode tab 210 may be electrically connected to the terminal plate 250 by contacting the contact portion 212 with the insertion portion 254.

In an embodiment, in a secondary cell having an electrode assembly received and a cap assembly coupled thereto, the electrode tab 210 may be bent under the cap assembly. In more detail, the connection portion of the electrode assembly and the electrode tab 210 may be bent, so that the electrode tab 210 is bent toward the electrode assembly.

In an embodiment, the electrode tab 210 may include a bridge portion 214 connecting the first electrode to the contact portion 212, and a bending portion 216 that is a region bent between the contact portion 212 and the bridge portion 214. A position of the bending portion 216 may correspond to or substantially correspond to a position of a bottom surface of the insertion portion 254 in a height direction of the secondary battery. The bottom surface of the insertion portion 254 may be a surface that contacts the contact portion 212. As such, the contact portion 212 may be parallel to or substantially parallel to the electrode assembly and/or to the bottom surface of the insertion portion 254.

In an embodiment, a distance D from a bottom surface of the cap plate 230 to the bottom surface of the insertion portion 254 may be a suitable distance (e.g., a predetermined distance) or more. For example, the distance D from the bottom surface of the cap plate to the bottom surface of the insertion portion may be in a range from 80 μm to 180 μm. As a result, when the cap assembly is connected to (e.g., coupled to or attached to) the case accommodating the electrode assembly, the electrode tab 210 may be spaced apart from the cap plate 230 and/or from the insulating member 220 by the insertion portion 254 of the terminal plate 250. In other words, the electrode tab 210 may have more difficulty contacting the bottom surface of the cap plate 230 and/or the insulating member 220.

If the electrode assembly moves within the secondary battery, the electrode tab 210 may move slightly. As another example, the electrode tab 210 may move slightly or become slightly twisted as the secondary battery is shaken. In such cases, even if the electrode tab 210 moves, the bending portion 216 may serve as a buffer to prevent damage to the electrode tab 210. Additionally, a contact between the electrode tab 210 and the bottom surface of the cap plate 230 and/or contact between the electrode tab 210 and the insulating member 220 may be prevented or reduced, thereby preventing damage to the cap plate 230 and/or the insulating member 220.

FIG. 3 is a partial enlarged view of an electrode tab 310 according to an embodiment of the present disclosure. The electrode tab 310 may be in contact with and electrically connected to the terminal plate 250. In more detail, the electrode tab 310 may make contact with the insertion portion 254. The electrode tab 310 may be connected to the first electrode. Further, the electrode tab 310 may have a plurality of edges.

In an embodiment, the electrode tab 310 may have a first side surface 312 located at one end of the electrode tab 310. In this case, another end (e.g., an opposite end) of the electrode tab 310 may be opposite to the one end of the electrode tab 310 where the first side surface 312 is located. The other end of the electrode tab 310 may be connected to the first electrode.

In an embodiment, the first side surface 312 of the electrode tab 310 may have edges 314_1 to 314_4. Among the edges of the first side surface 312, at least one of the edges 314_1 to 314_4 may be chamfered. For example, the edges 314_1 to 314_4 of the first side surface 312 may include a first edge 314_1 that is connected to a top surface 316 of the electrode tab. Further, the edges 314_1 to 314_4 of the first side surface 312 may include a second edge 314_2 that is opposite to the first edge 314_1. Furthermore, the edges 314_1 to 314_4 of the first side surface 312 may include a third edge 314_3 and a fourth edge 314_4, each of which is connected with the first edge 314_1 and the second edge 314_2. At least one of the first edge 314_1, the second edge 314_2, the third edge 314_3, or the fourth edge 314_4 may be chamfered.

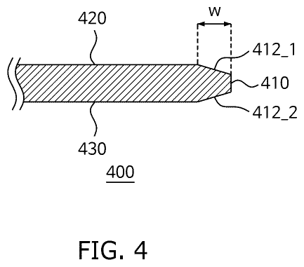

In an embodiment, the top surface 316 of the electrode tab may be positioned to face the terminal plate 250. The top surface 316 of the electrode tab may have the edge 314_1 and edges 318_1 and 318_2. For example, the edges 314_1, 318_1, and 318_2 of the top surface 316 may include the first edge 314_1, a fifth edge 318_1, and a sixth edge 318_2. The fifth edge 318_1 and the sixth edge 318_2 may be the edges connected with the first edge 314_1 from among the edges 314_1, 318_1, and 318_2 of the top surface 316. At least one of the first edge 314_1, the fifth edge 318_1, or the sixth edge 318_2 may be chamfered. The structure of the chamfered edge will be described in more detail below with reference to FIGS. 4 to 7.

FIG. 4 is a side view of a chamfered electrode tab 400 according to an embodiment of the present disclosure. The chamfered electrode tab 400 shown in FIG. 4 may be an example in which some of the edges of the electrode tab 300 described above with reference to FIG. 3 are chamfered.

In an embodiment, the chamfered electrode tab 400 may have a first side surface 410 located at one end of the chamfered electrode tab 400. In this case, another end (e.g., an opposite end) of the chamfered electrode tab 400 may be opposite to the one end of the chamfered electrode tab 400 where the first side surface 410 is located. The other end of the chamfered electrode tab 400 may be connected to the first electrode. Additionally, a top surface 420 of the electrode tab may be positioned to face the terminal plate. A bottom surface 430 of the electrode tab may be opposite to the top surface 420. In a secondary battery where the electrode assembly is accommodated and the cap assembly is coupled, the bottom surface 430 of the electrode tab may be positioned to face the electrode assembly.

In an embodiment, the chamfered electrode tab 400 may have a chamfered first edge 412_1 and a chamfered second edge 412_2. The chamfered first edge 412_1 may be connected with the top surface 420 of the electrode tab and the first side surface 410 of the electrode tab. The chamfered second edge 412_2 may be connected with the bottom surface 430 of the electrode tab and the first side surface 410 of the electrode tab. Referring to FIG. 4, both the first edge 412_1 and the second edge 412_2 are shown as being chamfered, but the present disclosure is not limited thereto. For example, the first edge 412_1 may be chamfered and the second edge 412_2 may not be chamfered.

In an embodiment, an edge (e.g., each edge) may be chamfered with a suitable width and thickness (e.g., a predetermined width and thickness). For example, the width (W) of the chamfered first edge 412_1 may be in a range from 20 μm to 150 μm. Further, the thickness of the chamfered first edge 412_1 may be less than half of the thickness of the first side surface 410 of the electrode tab. The chamfered second edge 412_2 may be chamfered in the same or substantially the same (or a similar) manner to that of the chamfered first edge 412_1, but the present disclosure is not limited thereto. For example, the width and thickness of the chamfered second edge 412_2 may be different from those of the chamfered first edge 412_1.

The chamfering of the edges may be achieved using various suitable metal processing methods. For example, the chamfering may be performed through at least one of cutting, rolling, or polishing. Referring to FIG. 4, the chamfering of the edges may result in sharp edges (e.g., edges with angled slopes).

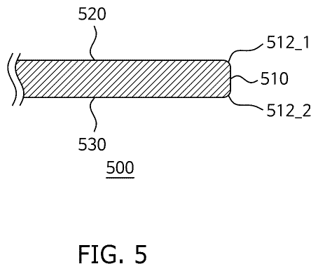

FIG. 5 is a side view of a chamfered electrode tab 500 according to an embodiment of the present disclosure. The chamfered electrode tab 500 shown in FIG. 5 may have a different chamfered structure when compared to the chamfered electrode tab 400 described above with reference to FIG. 4.

The chamfered electrode tab 500 may have a chamfered first edge 512_1 and a chamfered second edge 512_2. The chamfered first edge 512_1 may be connected with a top surface 520 of the electrode tab and a first side surface 510 of the electrode tab. The chamfered second edge 512_2 may be connected with a bottom surface 530 of the electrode tab and the first side surface 510 of the electrode tab. Referring to FIG. 5, the chamfering of the edges may result in rounded edges.

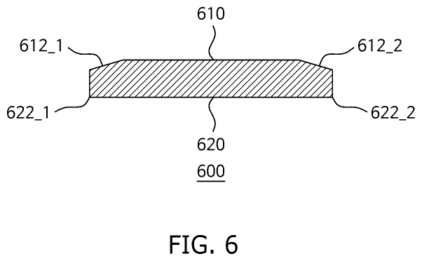

FIG. 6 is a cross-sectional view of a chamfered electrode tab 600 according to an embodiment of the present disclosure. The chamfered electrode tab 600 may be obtained by chambering the fifth edge 318_1 and the sixth edge 318_2 from the electrode tab 310 described above with reference to FIG. 3. FIG. 6 may be a cross-sectional view taken along the line A-A′ of the electrode tab 310 shown in FIG. 3.

A top surface 610 of the electrode tab may be positioned to face the terminal plate. A bottom surface 620 of the electrode tab may be opposite to the top surface 610. In a secondary battery where the electrode assembly is accommodated and the cap assembly is coupled, the bottom surface 620 of the electrode tab may be positioned to face the electrode assembly.

In an embodiment, a first side surface of the electrode tab 600 may have a first edge. The first edge may be connected with the top surface 610 of the electrode tab. In other words, the top surface 610 of the electrode tab may have the first edge. In an embodiment, the top surface 610 of the electrode tab may have a

plurality of edges. Among the edges, the top surface 610 may include a chamfered second edge 612_1 and a chamfered third edge 612_2 that are connected with the first edge. Similarly, the bottom surface 620 of the electrode tab may have a plurality of edges. Among the edges, the bottom surface 620 may include a fourth edge 622_1 opposite to the chamfered second edge 612_1, and a fifth edge 622_2 opposite to the chamfered third edge 612_2. Referring to FIG. 6, the fourth edge 622_1 and the fifth edge 622_2 may not be chamfered. However, the present disclosure is not limited thereto, and the fourth edge 622_1 and the fifth edge 622_2 may also be chamfered the same or substantially the same as (or similarly to) those of the chamfered second edge 612_1 and the chamfered third edge 612_2.

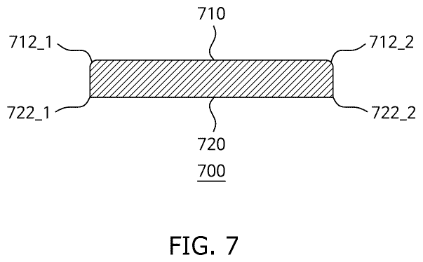

FIG. 7 is a cross-sectional view of a chamfered electrode tab 700 according to an embodiment of the present disclosure. The chamfered electrode tab 700 shown in FIG. 7 may have a different chamfered structure when compared to the chamfered electrode tab 600 described above with reference to FIG. 6. In more detail, a top surface 710 of the electrode tab may be positioned to face the terminal plate, and a bottom surface 720 of the electrode tab may be opposite to the top surface 710.

A first side surface of the chamfered electrode tab 700 may have a first edge that is connected with the top surface 710 of the electrode tab. The top surface 710 may have a chamfered second edge 712_1 and a chamfered third edge 712_2 that are connected with the first edge. The bottom surface 720 of the electrode tab may have a fourth edge 722_1 opposite to the chamfered second edge 712_1, and a fifth edge 722_2 opposite to the chamfered third edge 712_2.

Referring to FIG. 7, the chamfered second edge 712_1 may be a rounded edge. Similarly, the chamfered third edge 712_2 may also be a rounded edge. However, the present disclosure is not limited thereto, and at least one of the chamfered second edge 712_1 or the chamfered third edge 712_2 may be rounded. Further, the fourth edge 722_1 and the fifth edge 722_2 may not be chamfered. However, the present disclosure is not limited thereto, and the fourth edge 722_1 and the fifth edge 722_2 may also be chamfered the same or substantially the same as (or similarly to) those of the chamfered second edge 712_1 and the chamfered third edge 712 2.

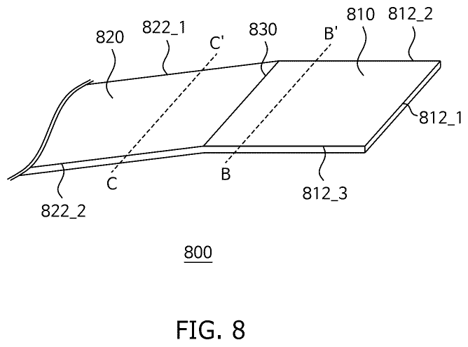

FIG. 8 illustrates an example of an electrode tab 800 according to an embodiment of the present disclosure. The electrode tab 800 may be connected to the first electrode. The electrode tab 800 may include a contact portion 810 that contacts the terminal plate. Additionally, the electrode tab 800 may include a bridge portion 820 that connects the first electrode to the contact portion 810, and a bending portion 830 that is a region bent between the contact portion 810 and the bridge portion 820. In an embodiment, a top surface of the contact portion 810 may be

positioned to face the terminal plate within a secondary battery. The top surface of the contact portion 810 may include a first edge 812_1, a second edge 812_2, and a third edge 812_3. The first edge 812_1 may be opposite to the bending portion 830. The second edge 812_2 and third edge 812_3 may be connected to the first edge 812_1 and the bending portion 830. At least one of the first edge 812_1, the second edge 812_2, or the third edge 812_3 of the top surface of the contact portion 810 may be chamfered.

In an embodiment, a top surface of the bridge portion 820 may be positioned to face the terminal plate within the secondary battery. The top surface of the bridge portion 820 may have a fourth edge 822_1 and a fifth edge 822_2. Each of the fourth edge 822_1 and the fifth edge 822_2 may be connected with the bending portion 830. At least one of the fourth edge 822_1 or the fifth edge 822_2 of the top surface of the bridge portion 820 may be chamfered.

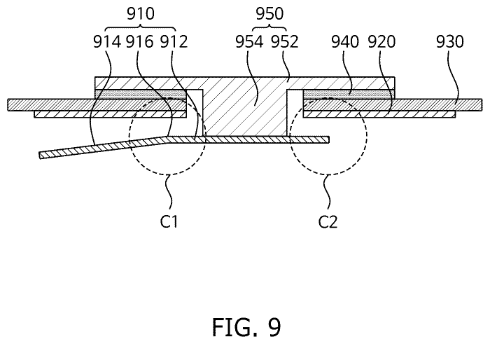

The structure of the chamfered edges may be understood based on the chamfered electrode tabs described above with reference to FIGS. 4 to 7. For example, a cross-sectional view taken along the line B-B′ of the contact portion 810 shown in FIG. 8 may be the same as or substantially the same as (or similar to) that of the chamfered electrode tab 600 described above with reference to FIG. 6, or that of the chamfered electrode tab 700 described above with reference to FIG. 7. For example, a cross-sectional view taken along the line C-C′ of the bridge portion 820 shown in FIG. 8 may be the same or substantially the same as (or similar to) that of the chamfered electrode tab 600 described above with reference to FIG. 6, or that of the chamfered electrode tab 700 described above with reference to FIG. 7. For example, the chamfered appearance of a first side surface of the contact portion 810 opposite to the bending portion 830 may be the same as or substantially the same as (or similar to) that of the chamfered electrode tab 400 described above with reference to FIG. 4, or that of the chamfered electrode tab 500 described above with reference to FIG. 5. FIG. 9 illustrates an example of a cap assembly and an electrode tab 910

according to an embodiment of the present disclosure. The cap assembly may include an insulating member 920, a cap plate 930, an insulating layer 940, and a terminal plate 950. The terminal plate 950 may include a body portion 952 and an insertion portion 954. The insulating layer 940 may be disposed between the body portion 952 and the cap plate 930. The insertion portion 954 may be inserted into an insertion hole formed in the cap plate 930.

The electrode tab 910 may be connected to the first electrode. The electrode tab 910 may include a contact portion 912 that contacts the terminal plate 950. The electrode tap 910 may also include a bridge portion 914 connecting the first electrode to the contact portion 912, and a bending portion 916 formed between the contact portion 912 and the bridge portion 914.

In an embodiment, the electrode tab 910 may be chamfered. Referring to FIG. 9, although the electrode tab 910 is not shown as being chamfered, the electrode tab 910 may be the same or substantially the same as (or similar to) one of the chamfered electrode tabs described above with reference to FIGS. 4 to 8.

Referring to FIG. 9, a first region C1 may indicate an area where the electrode tab 910 may be more easily in contact with the insulating member 920. For example, at least a portion of the top surface of the bridge portion 914 and at least a portion of the top surface of the contact portion 912 may be more easily brought into contact with the insulating member 920. The edges of the top surface of the bridge portion 914 and/or the edges of the top surface of the contact portion 912 may be chamfered, and as a result, the edges of the electrode tab 910 corresponding to the first region C1 may be blunt. As a result, the contact of the insulating member 920 with the electrode tab 910 may not cause damage to the insulating member 920.

A second region C2 may indicate an area where the electrode tab 910 is more easily to be in contact with the insulating member 920. For example, at least a portion of a first side surface (e.g., the first side surface 312 shown in FIG. 3) of the electrode tab 910 and at least a portion of a top surface of the contact portion 912 may be more easily brought into contact with the insulating member 920. The edges of the first side surface of the electrode tab 910 and/or the edges of the top surface of the contact portion 912 may be chamfered, and as a result, the edges of the electrode tab 910 corresponding to the second region C2 may be blunt. As a result, the contact of the insulating member 920 with the electrode tab 910 may not cause damage to the insulating member 920.

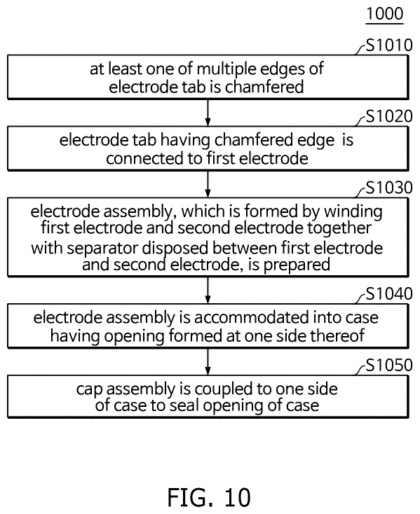

FIG. 10 is a flowchart illustrating an example of a method 1000 for manufacturing a secondary battery according to an embodiment of the present disclosure. A secondary battery manufacturing apparatus may be used for manufacturing the secondary battery according to an embodiment of the present disclosure.

In an embodiment, the method 1000 for manufacturing a secondary battery may start, and at least one of a plurality of edges of an electrode tab may be chamfered (S1010), for example, using the secondary battery manufacturing apparatus. For example, the secondary battery manufacturing apparatus may chamfer at least one of the plurality of edges of the electrode tab through at least one of cutting or rolling, thereby rounding the edge. For example, the chamfered edge may have a width ranging from 20 μm to 150 μm.

In an embodiment, the secondary battery manufacturing apparatus may connect the electrode tab having the chamfered edge to a first electrode (S1020).

In an embodiment, the secondary battery manufacturing apparatus may prepare an electrode assembly, which is formed by winding a first electrode and a second electrode together with a separator disposed between the first electrode and the second electrode (S1030).

In an embodiment, the secondary battery manufacturing apparatus may accommodate the electrode assembly into a case having an opening formed at one side thereof (S1040).

In an embodiment, the secondary battery manufacturing apparatus may connect (e.g., couple or attach) a cap assembly to one side of the case to seal the opening of the case (S1050), and the method 1000 may end. The cap assembly may include a terminal plate that is electrically connected to the electrode tab connected to the first electrode. In more detail, a top surface of the electrode tab may face the terminal plate, and at least one of the edges of the top surface of the electrode tab from among the plurality of edges may be chamfered.

In an embodiment, the electrode tab may have a first side surface located at one end of the electrode tab, another end (e.g., an opposite end) of the electrode tab that is opposite to the one end of the electrode tab may be connected to the first electrode, and at least one of the edges of the first side surface of the electrode tab from among the plurality of edges may be chamfered.

In an embodiment, the top surface of the electrode tab may be positioned to face the terminal plate, and the plurality of edges may include a first edge. The first side surface of the electrode tab may have the first edge, so that the first edge is connected with the top surface of the electrode tab, and the first edge may be chamfered. Further, the plurality of edges may further include a second edge, a third edge, and a fourth edge. The first side surface of the electrode tab may have the second edge opposite to the first edge, and the third edge and the fourth edge, each of which is connected with the first edge and the second edge. Further, at least one of the second edge, the third edge, or the fourth edge may be chamfered.

In an embodiment, the electrode tab may include a contact portion that contacts the terminal plate, a bridge portion connecting the first electrode and the contact portion, and a bending portion formed between the contact portion and the bridge portion.

In an embodiment, the plurality of edges may include a fifth edge. A top surface of the contact portion may be positioned to face the terminal plate. The top surface of the contact portion may have the fifth edge, so that the fifth edge is located at one end that is opposite to the bending portion, and the fifth edge may be chamfered. Further, the plurality of edges may further include a sixth edge and a seventh edge. The top surface of the contact portion may have the sixth edge and the seventh edge, so that each of the sixth edge and the seventh edge is connected with the fifth edge and the bending portion, and at least a portion of the sixth edge and at least a portion of the seventh edge may be chamfered. Further, the plurality of edges may further include an eighth edge and a ninth edge. A top surface of the bridge portion may be positioned to face the terminal plate. The top surface of the bridge portion may have the eighth edge and the ninth edge, so that each of the eighth edge and the ninth edge is connected with the bending portion, and at least a portion of the eighth edge and at least a portion of the ninth edge may be chamfered.

In an embodiment, the terminal plate may include a body portion, and an insertion portion formed to protrude from the body portion. The cap assembly may further include a cap plate that is fitted and connected to (e.g., coupled to or attached to) the opening of the case, and has a through-hole (e.g., an insertion hole) through which the insertion portion of the terminal plate passes, and an insulating member disposed on a bottom surface of the cap plate. The terminal plate may be electrically connected to the electrode tab by contact of the insertion portion with the electrode tab. Further, the insulating member may have a thickness of 30 μm or more.

In an embodiment, a distance from the bottom surface of the cap plate to a bottom surface of the insertion portion may be in a range from 80 μm to 180 μm. Further, the electrode tab may be spaced apart from the insulating member by the insertion portion of the terminal plate when the cap assembly is connected to (e.g., coupled to or attached to) the case in which the electrode assembly is accommodated.

In an embodiment, the secondary battery may be a coin-kind of secondary battery or a button-kind of secondary battery.

However, the present disclosure is not limited to the method 1000 described above with reference to the flowchart of FIG. 10. For example, one or more processes or blocks in the flowchart may be added, modified, or deleted; the sequence of one or more processes or blocks may be changed; and/or one or more processors or blocks may be performed concurrently (e.g., simultaneously or substantially simultaneously) with each other.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

What is claimed is:

1. A secondary battery comprising:
an electrode assembly comprising:
a first electrode;
a second electrode; and
a separator between the first electrode and the second electrode, the first electrode and the second electrode being wound together with the separator therebetween;
an electrode tab connected to the first electrode;
a case having an opening at one side, and configured to accommodate the electrode assembly; and
a cap assembly coupled to the one side of the case to seal the opening of the case, and comprising a terminal plate electrically connected to the electrode tab connected to the first electrode,
wherein the electrode tab comprises a plurality of edges, and at least one of the plurality of edges is chamfered.

2. The secondary battery as claimed in claim 1, wherein a top surface of the electrode tab faces the terminal plate, and
wherein at least one edge of the top surface from among the plurality of edges is chamfered.

3. The secondary battery as claimed in claim 1, wherein the electrode tab comprises a first side surface located at one end of the electrode tab,
wherein another end of the electrode tab that is opposite to the one end is connected to the first electrode, and
wherein at least one edge of the first side surface from among the plurality of edges is chamfered.

4. The secondary battery as claimed in claim 3, wherein a top surface of the electrode tab faces the terminal plate,
wherein the plurality of edges comprises a first edge,
wherein the first side surface of the electrode tab comprises the first edge that is connected with the top surface of the electrode tab, and
wherein the first edge is chamfered.

5. The secondary battery as claimed in claim 3, wherein the plurality of edges comprise a first edge, a second edge, a third edge, and a fourth edge,
wherein the first side surface of the electrode tab comprises:
the second edge opposite to the first edge; and
the third edge and the fourth edge, each of which is connected to the first edge and the second edge, and
wherein at least one of the second edge, the third edge, or the fourth edge is chamfered.

6. The secondary battery as claimed in claim 1, wherein the electrode tab comprises:
a contact portion in contact with the terminal plate;
a bridge portion connecting the first electrode and the contact portion to each other; and
a bending portion between the contact portion and the bridge portion.

7. The secondary battery as claimed in claim 6, wherein the plurality of edges further comprises a fifth edge,
wherein a top surface of the contact portion faces the terminal plate,
wherein the top surface of the contact portion comprises the fifth edge at one end opposite to the bending portion, and
wherein the fifth edge is chamfered.

8. The secondary battery as claimed in claim 7, wherein the plurality of edges further comprises a sixth edge and a seventh edge,
wherein the top surface of the contact portion comprises the sixth edge and the seventh edge, each connected to the fifth edge and the bending portion, and
wherein at least a portion of the sixth edge and at least a portion of the seventh edge are chamfered.

9. The secondary battery as claimed in claim 6, wherein the plurality of edges further comprises an eighth edge and a ninth edge,
wherein a top surface of the bridge portion faces the terminal plate,
wherein the top surface of the bridge portion comprises the eighth edge and the ninth edge, each connected to the bending portion, and
wherein at least a portion of the eighth edge and at least a portion of the ninth edge are chamfered.

10. The secondary battery as claimed in claim 1, wherein the at least one of the plurality of edges is chamfered by cutting or rolling.

11. The secondary battery as claimed in claim 1, wherein a width of the at least one of the plurality of edges that is chamfered is in a range from 20 μm to 150 μm.

12. The secondary battery as claimed in claim 1, wherein the at least one of the plurality of edges that is chamfered is a rounded edge.

13. The secondary battery as claimed in claim 1, wherein the terminal plate comprises a body portion, and an insertion portion protruding from the body portion, and
wherein the cap assembly further comprises:
a cap plate fitted into and coupled to the opening of the case, the cap plate having a through-hole through which the insertion portion of the terminal plate is configured to pass through; and
an insulating member on a bottom surface of the cap plate.

14. The secondary battery as claimed in claim 13, wherein the terminal plate is electrically connected to the electrode tab by the insertion portion contacting the electrode tab.

15. The secondary battery as claimed in claim 13, wherein a thickness of the insulating member is 30 μm or more.

16. The secondary battery as claimed in claim 13, wherein a distance from the bottom surface of the cap plate to a bottom surface of the insertion portion is in a range from 80 μm and 180 μm.

17. The secondary battery as claimed in claim 13, wherein the electrode tab is spaced from the insulating member by the insertion portion of the terminal plate when the cap assembly is coupled to the case accommodating the electrode assembly.

18. The secondary battery as claimed in claim 1, wherein the secondary battery is a coin kind or a button kind.

19. A method for manufacturing a secondary battery, comprising:
forming a chamfered edge by chamfering at least one of a plurality of edges of an electrode tab;
connecting the electrode tab having the chamfered edge to a first electrode;
forming an electrode assembly by winding the first electrode and a second electrode together with a separator disposed between the first electrode and the second electrode;
accommodating the electrode assembly in a case having an opening formed at one side; and
coupling a cap assembly to the one side of the case to seal the opening of the case;
wherein the cap assembly comprises a terminal plate electrically connected to the electrode tab connected to the first electrode.

20. The method as claimed in claim 19, wherein the forming of the chamfered edge comprises:
chamfering the at least one of the plurality of edges of the electrode tab to have a rounded shape through at least one of cutting or rolling.
